(19) United States
(12) Patent Application Publication
(10) Pub. No.: US 2012/0307332 A1
(43) Pub. Date: Dec. 6, 2012

(54) DISPLAY DEVICE

(75) Inventors: Naohisa ANDO, Mobara (JP); Takahiko Muneyoshi, Chiba (JP); Kazufumi Watabe, Yotsukaido (JP); Mitsuhide Miyamoto, Chiba (JP); Takahide Kuranaga, Mobara (JP)

(73) Assignee: Hitachi Displays, Ltd.

(21) Appl. No.: 13/483,081

(22) Filed: May 30, 2012

(30) Foreign Application Priority Data
Jun. 3, 2011 (JP) 2011-125146

(51) Int. Cl. G02B 26/02

(52) U.S. Cl. 359/230

(57) ABSTRACT

A display device includes an aperture substrate including a plurality of openings arranged in a matrix form and a plurality of shutter parts that are arranged between a first substrate and a second substrate correspondingly to the openings. The plurality of shutter parts move in a horizontal direction relative to the aperture substrate so as to control an amount of light emitted from the plurality of openings. Also, the display device includes a liquid holding wall configured to hold a liquid between the first substrate and the second substrate and is arranged to surround a display area including the plurality of shutter parts, and includes at least one bubble holding part configured to hold a bubble that is generated in the liquid and is guided to the at least one bubble holding part. The at least one bubble holding part is provided as a part of the liquid holding wall.

### CROSS-REFERENCE TO RELATED APPLICATION

The present application claims priority from Japanese Application JP2011-125146 filed on Jun. 3, 2011, the content to which is hereby incorporated by reference into this application.

### BACKGROUND OF THE INVENTION

1. Field of the Invention

One or more embodiments of the present invention relates to a display device, and particularly to a display device using a micro electromechanical system, that is, a MEMS (Micro Electro Mechanical System) shutter system.

2. Description of the Related Art

As a display device replacing a liquid crystal display device or the like, an attention is paid to a display device using a MEMS shutter system. The display is different from a liquid crystal shutter system using polarized light, and is a system, as indicated by the name, to display brightness and darkness by opening and closing a mechanical shutter by controlling light from a light source (see JP 2008-197668A).

### SUMMARY OF THE INVENTION

As compared with a normal liquid crystal display, the display device has merits that light use efficiency of backlight is very high, power consumption is low, and color reproducibility is excellent.

The mechanical shutter is operated by applying a voltage between an electrode plate, which is arranged to extend on both sides of the mechanical shutter, and a power supply electrode plate, which is arranged correspondingly to the electrode plate, so as to generate an electrostatic attraction between the electrode plate and the power supply electrode plate. Here, it is conceivable that for example, a cell, in which the mechanical shutter operates, is filled with a liquid, for example, silicone oil, enhancing a dielectric constant so as to lower the voltage required to drive the mechanical shutter.

However, there is a problem that when the temperature becomes low, for example, when the temperature falls to a freezing point or below, the liquid such silicone oil is contracted so that a bubble is generated in the cell, and consequently, the image quality is deteriorated.

In view of the above, the invention has an object to provide a display device having higher image quality in which even if a bubble is generated in a liquid in a cell in which a mechanical shutter operates, the influence of the bubble is prevented.

(1) According to an aspect of the invention, a display device includes an aperture substrate including a plurality of openings arranged in a matrix form and a plurality of shutter parts that are arranged between a first substrate and a second substrate correspondingly to the plurality of openings. The plurality of shutter parts move in a horizontal direction relative to the aperture substrate so as to control an amount of light emitted from the plurality of openings. The display device also includes a liquid holding wall configured to hold a liquid between the first substrate and the second substrate and is arranged to surround a display area including the plurality of shutter parts. The display device further includes at least one bubble holding part configured to hold a bubble that is generated in the liquid and is guided to the at least one bubble holding part. The at least one bubble holding part is provided as a part of the liquid holding wall.

(2) In the display device of (1), the bubble holding part is arranged outside the display area.

(3) In the display device of (1) or (2), four bubble holding parts including the at least one bubble holding part are provided so as to be continuous with ends of the liquid holding wall.

(4) In the display device of any one of (1) to (3), the at least one bubble holding part includes a guide wall to guide the bubble to an inside of the bubble holding part.

(5) In the display device of (4), the guide wall has a width which becomes narrow toward the outside of the display area.

(6) In the display device of any one of (1) to (5), the at least one bubble holding part includes a movement preventing wall so as to prevent the bubble from moving to the display area from the bubble holding part.

(7) In the display device of (6), the movement preventing wall is formed in an L shape, and is arranged so as to cause the bubble guided from the guide wall to move toward an outside of the bubble holding part.

(8) In the display device of (6) or (7), the liquid holding wall, the bubble holding wall, the guide wall and the movement preventing wall are made of a same seal member.

(9) In the display device of any one of (1) to (8), each of the shutter parts includes an electrode plate. The display device further includes a power supply electrode plate arranged to face the electrode plate. The shutter part is moved by applying a voltage between the electrode plate and the power supply electrode plate. The liquid enhances a dielectric constant between the electrode plate and the power supply electrode plate as compared with a case where the liquid is not sealed.

(10) In the display device of anyone of (1) to (9), the liquid is a silicone oil.

(11) In the display device of any one of (1) to (10), the display area further includes a light source part, and the shutter parts control an amount of light emitted from the light source part through the plural openings of the aperture substrate.

Even when a bubble is generated in a liquid in the cell, in which mechanical shutter operates, one or more embodiments of the present invention provides a display device that prevents an influence of the bubble so as to realize higher image quality.

### BRIEF DESCRIPTION OF THE DRAWINGS

FIG. 1 is a view for explaining the outline of a display device of an embodiment of the invention;

FIG. 2 is a view for explaining the structure of a shutter part;

FIG. 3 is a view for explaining the structure of the shutter part;

FIG. 4 is a view for explaining the outline of a TFT substrate;

FIG. 5 is a view for explaining an example of the structure of each pixel included in a display area;

FIG. 6 is a view for explaining a seal member in the embodiment;

FIG. 7 is an enlarged view of the periphery of a bubble holding part shown in FIG. 6;

FIG. 8A is a view for explaining a modified example of the invention;

FIG. 8B is a view for explaining a modified example of the invention; and

FIG. 8C is a view for explaining a modified example of the invention.

### DETAILED DESCRIPTION OF THE INVENTION

Hereinafter, embodiments of the invention will be described with reference to the drawings. In the drawings, the same or equivalent component is denoted by the same reference numeral, and a duplicate description thereof is omitted.

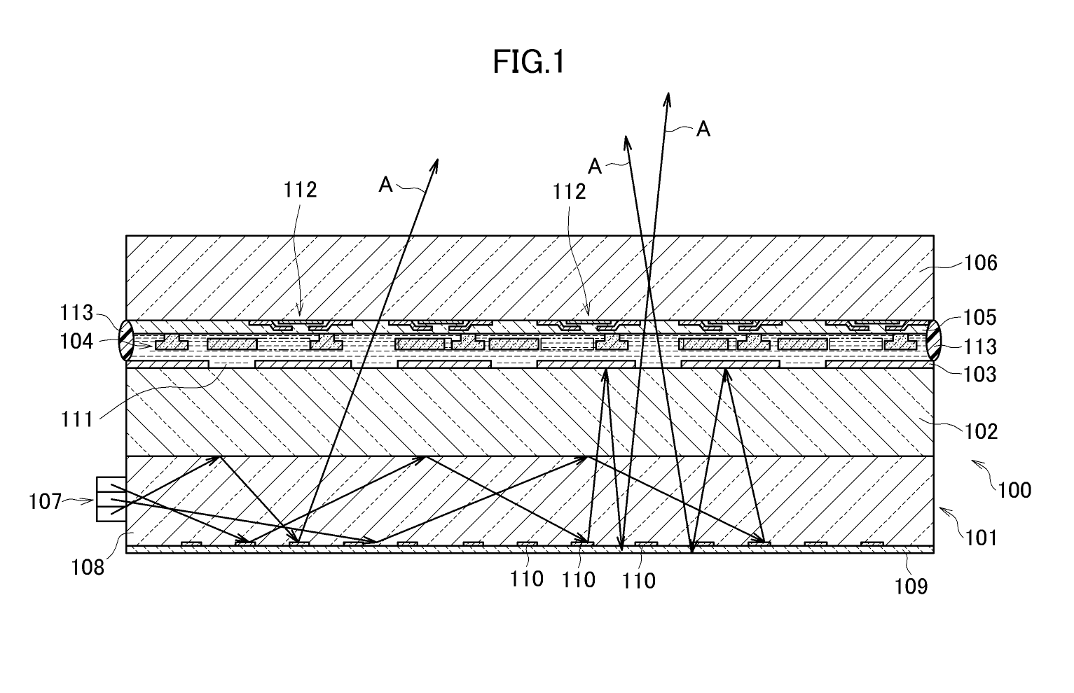

FIG. 1 is a view for explaining the outline of a display device of an embodiment of the invention. Specifically, FIG. 1 shows the outline of a section of the display device. As shown in FIG. 1, a display device 100 includes, for example, a backlight 101, a glass substrate 102, an aperture substrate 103 including plural openings 111, plural shutter parts 104, a TFT (Thin Film Transistor) substrate 105 and a back plate 106.

The backlight 101 includes, for example, a light source 107 including LEDs of RGB, a light guide part 108 to guide light from the light source 107, and a reflecting sheet 109 placed on a lower part of the light guide part. The light guide part 108 reflects the light from the light source 107 at an upper surface and a lower surface of the light guide part 108. Further, the light guide part includes light scattering parts 110 arranged in a specified pattern on the lower surface, and scatters the light from the light source. Thus, the light from the light source 107 is uniformed and is irradiated upward from the light guide part 108. In addition, because the details of the light guide part 108 are well known, a detailed description thereof is omitted. The glass substrate 102 is laminated on the backlight 101.

The aperture substrate 103 includes a reflecting layer laminated on the glass substrate 102 and an antireflection layer laminated on the reflecting layer, which will be described later, and includes the plural openings 111 through which the light from the backlight 101 passes. Thus, for example, as shown in FIG. 1, the light from the backlight 101 passes through the openings 111 directly through the glass substrate 102, or passes through the openings after being reflected by the reflecting layer and being again reflected by the lower part of the light guide part 108. Incidentally, as the reflecting layer, for example, Ag or Al is used, and as the antireflection layer, for example, black chromium is used.

The shutter parts 104 are arranged between a pair of glass substrates, for example, the TFT substrate 105 and the glass substrate 102 laminated with the aperture substrate 103. The shutter part 104 moves in the horizontal direction relative to the aperture substrate 103, and controls the amount of light passing toward the TFT substrate 105 side among the light from the opening 111. Specifically, if the shutter part 104 is positioned in a closed state, the light from the opening 111 is blocked, and if the shutter part 104 is positioned in an opened state, the light from the opening 111 passes toward the TFT substrate 105 side as indicated by an arrow A. For example, in FIG. 1, the first and third shutter parts from the left are in the closed state, and the second and fourth shutter parts from the left are in the opened state. In addition, the detailed structure of the shutter part 104 will be described later.

The TFT substrate 105 includes TFTs 112 to control the movement of the respective shutter parts 104. An area surrounded by, for example, a seal member 113 is provided between the TFT substrate 105 and the glass substrate 102 that is laminated with the aperture substrate 103, and a liquid such as silicone oil is held in the area. Besides, the back plate 106, which is a transparent substrate to protect the TFT substrate 105, is placed on an upper part of the TFT substrate 105.

In addition, the structure of the display device 100 is an example, and one or more embodiments of the present inventions is not limited to the structure. The above structure may be replaced by a substantially same structure as the above structure, a structure having the same operation and effect, or a structure capable of achieving the same object. For example, in the above, although the description is made on the structure in the case where the display device 100 is of a so-called transmission type, a so-called semi-transmission type or reflection type structure may be used. In addition, when the reflection type structure is used, the light source 107 such as the LED is not required. Besides, in the above, it is described that the LED is used as the light source 107, another light-emitting element such as a fluorescent lamp may be used. Further, in the above, although the description is made on the case where the shutter part 104 is supported by the TFT substrate 105, the shutter part may be supported by the aperture substrate 103.

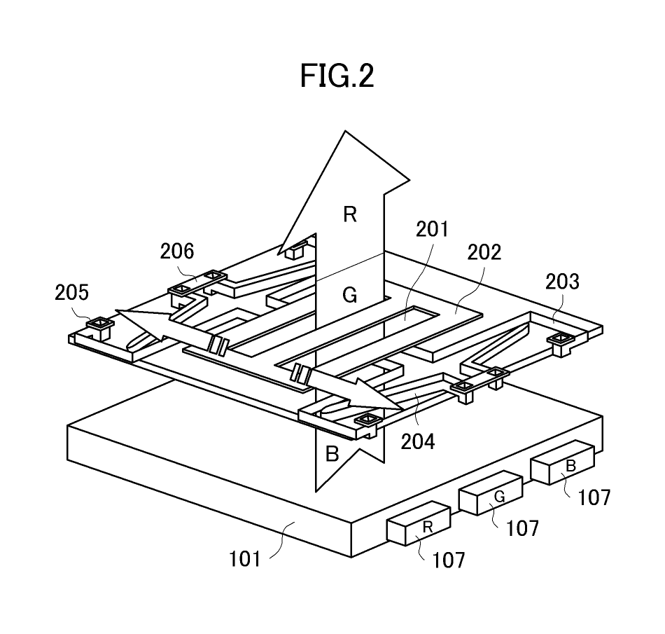

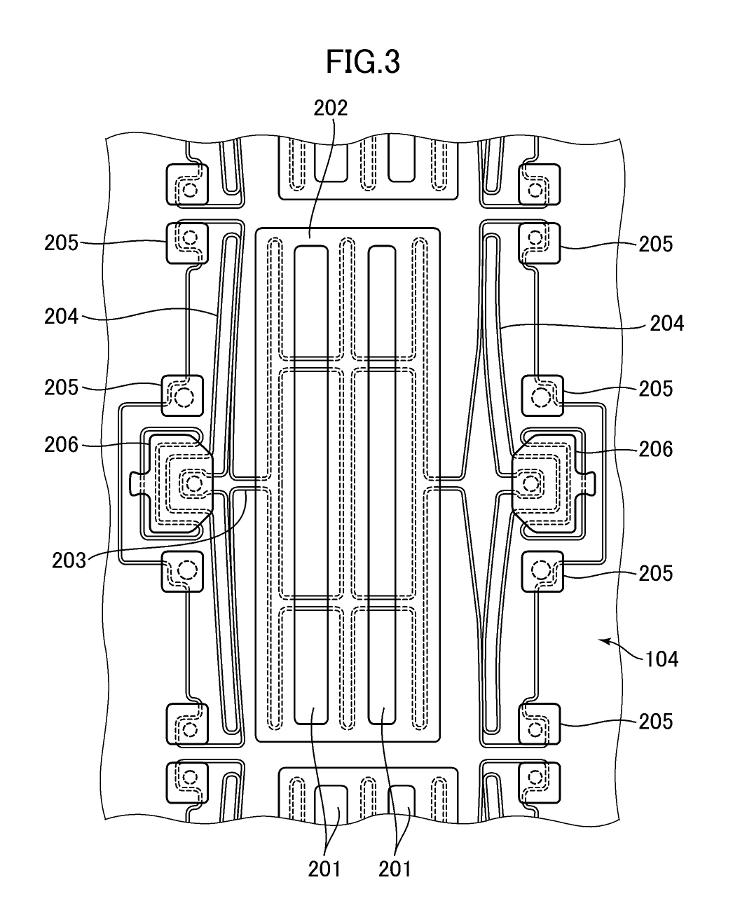

FIG. 2 and FIG. 3 are views for explaining the structure of the shutter part 104. Specifically, FIG. 2 is a perspective view mainly showing the shutter part, and FIG. 3 is a front view mainly showing the shutter part.

As shown in FIG. 2 and FIG. 3, the shutter part 104 includes a shutter main body 202 including plural shutter openings 201 as plural openings in the shutter part 104, and electrode plates 203 extending from the shutter main body 202 on both sides thereof. On the other hand, power supply electrode plates 204 are arranged at positions corresponding to the electrode plates 203. Besides, the electrode plates 203 and the power supply electrode plates 204 are supported by, for example, shutter support parts 205 provided on the TFT substrate 105 or the aperture substrate 103, and power supply electrode plate support parts 206. In addition, the shutter main body 202 includes, for example, a substantially rectangular shape, and the shutter main body 202 has a size of, for example, approximately 100×100 μm or less and has a thickness of several μm.

The electrode plates 203 and the power supply electrode plates 204 have such a shape as to operate like a spring as shown in FIG. 2 and FIG. 3, and can be elastically deformed when the shutter main body 202 moves. Specifically, for example, when a voltage is applied between one power supply electrode plate 204 and the electrode plate 203, an electrostatic attraction is generated between the power supply electrode plate 204 and the electrode plate 203, and the shutter main body 202 is attracted to the power supply electrode plate 204 side and is moved. However, when the voltage is turned off, a force acts in a direction opposite to the direction of the movement by an elastic force of the electrode plate 203 and the power supply electrode plate 204. In addition, for example, voltages of 25V and 0V are respectively applied to the power supply electrode plate 204 and the electrode plate 203.

When the shutter main body 202 is moved in the opposite direction as stated above, a voltage is applied between the other power supply electrode plate 204 and the electrode plate 203, and an electrostatic attraction between the other power supply electrode plate 204 and the electrode plate 203 may be used in addition to the elastic force.

In addition, here, FIG. 3 shows a case where the voltage is applied between the power supply electrode plate 204, and the electrode plate 203 at the left side of the drawing and the shutter main body 202 is moved to the left side. The electrode plate 203 and the power supply electrode plate 204 are formed of, for example, a-Si and are covered with an insulating film.

Besides, the openings 111 are provided in the aperture substrate 103 correspondingly to the shutter openings 201 of the shutter part 104. As stated above, when the voltage is applied between the electrode plate 203 and the one power supply electrode plate 204, the electrostatic attraction is generated between the electrode plate 203 and the one power supply electrode plate 204. As a result, the shutter part 104 is moved from the one power supply electrode plate 204 to the other power supply electrode plate 204 side.

At this time, for example, the shutter opening 201 and the opening 111 of the aperture substrate 103 overlap each other, and the shutter part 104 is brought into an opened state. On the other hand, for example, when the voltage is not applied (or the voltage is applied between the electrode plate 203 and the other power supply electrode plate 204), the shutter opening 201 and the opening 111 of the aperture substrate 103 do not overlap each other, and the shutter part 104 is brought into a closed state. In addition, although FIG. 2 and FIG. 3 show the structure in which two openings 111 are provided in the aperture substrate 103 and two shutter openings 201 are provided in the shutter part 104 for each pixel, a different number of openings 111 and shutter openings 201 may be provided.

As stated above, the shutter part 104 is brought into the opened state or the closed state, and the length of time in which lights of respective colors of RGB sequentially irradiated from the backlight 101 are allowed to pass or are blocked is controlled, so that the display of an image is realized. This point will be specifically described later.

In addition, the above structure is an example, and one or more embodiments of the present invention is not limited to the above structure. Specifically, for example, although it is described that the two power supply electrode plates 204 are arranged for the electrode plate 203 of the shutter part 104, one power supply electrode plate 204 may be arranged for the electrode plate 203 of the shutter part 104.

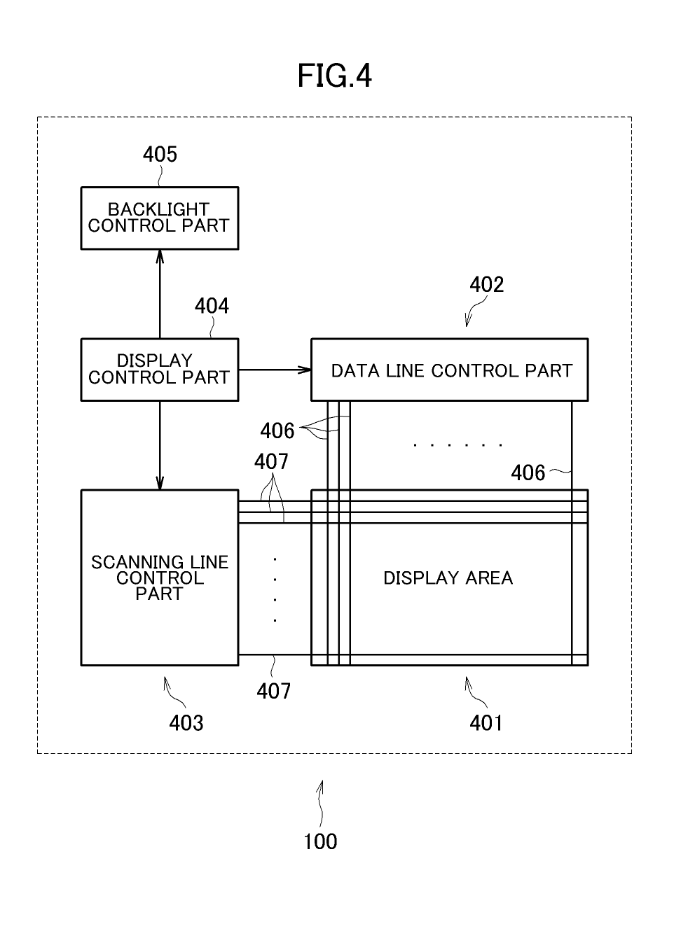

FIG. 4 is a view for explaining the outline of the TFT substrate shown in FIG. 1. As shown in FIG. 4, the TFT substrate 105 includes a display area 401 for displaying a display screen, a data line control part 402, a scanning line control part 403, a display control part 404 and a backlight control part 405. In addition, in FIG. 4, although the display control part 404, the data line control part 402 and the scanning line control part 403 are shown as separate units, they may be formed of one unit, or a part of the units may be provided on a substrate different from the TFT substrate 105.

The display area 401 includes plural pixels (not shown) arranged in a matrix form described later, and the plural pixels are respectively connected to corresponding data lines 406 and scanning lines 407. In addition, the respective data lines 406 are connected to the data line control part 402, and the respective scanning lines 407 are connected to the scanning line control part 403. Additionally, the plural pixels respectively include the openings 111 of the aperture substrate 103 corresponding to the shutter parts 104.

The display control part 404 is connected to the data line control part 402, the scanning line control part 403 and the backlight control part 405. A control signal group (not shown) is inputted to the display control part 404, and according to the control signal group, a data line control signal, a scanning line control signal and a backlight control signal are respectively outputted to the data line control part 402, the scanning line control part 403 and the backlight control part 405.

The data line control part 402 outputs voltage signals, which cause the shutter parts 104 to be brought into the opened state or the closed state, to the respective pixels through the data lines 406 according to the data line control signal from the display control part 404.

The scanning line control part 403 outputs scanning signals to control TFT switches (not shown) arranged for the respective pixels through the respective scanning lines 407 according to the scanning line control signal from the display control part 404.

The backlight control part 405 is connected to the light sources 107 of the respective colors of RGB, and sequentially turns on the light sources 107 of the respective colors of RGB according to the backlight control signal from the display control part 404.

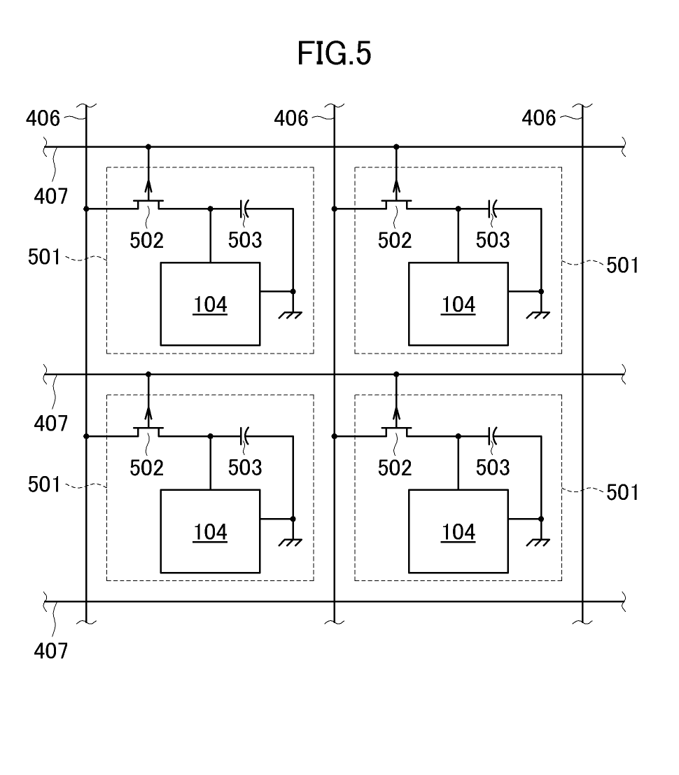

FIG. 5 is a view for explaining an example of the structure of the respective pixels included in the display area. As shown in FIG. 5, each of pixels 501 in the display area 401 includes the shutter part 104, the opening 111 of the aperture substrate 103 corresponding thereto, a TFT 502 and a holding capacitance 503. Besides, as stated above, the respective pixels 501 are respectively connected to the corresponding data lines 406 and the scanning lines 407.

A gate of the TFT 502 is connected to the scanning line 407, a source is connected to the data line 406, and a drain is connected to the power supply electrode plate 204 of the corresponding shutter part 104. Besides, one end of the holding capacitance 503 is connected to the drain of the TFT 502, and the other end is grounded. The electrode plate 203 of the shutter part 104 is grounded.

Next, the operation of the respective pixels 501 will be described. The scanning line control part 403 sequentially applies the scanning signal to the respective scanning lines 407. When the scanning signal is applied, in the pixel 501 corresponding to the scanning line 407, the TFT 502 of the pixel 501 is turned on, and the writing to the pixel is allowed. The data line control part 402 applies a data signal through the corresponding data line 406 to the pixel 501 to which the writing is allowed.

At this time, since the TFT 502 of the pixel 501 is turned on, a voltage signal corresponding to the data signal is applied to the power supply electrode plate 204 of the corresponding shutter part 104. Accordingly, the shutter part 104 of the pixel 501 is brought into, for example, the opened state. The applied data signal is held by the holding capacitance 503 of the pixel 501 after scanning, and thus, the on state of the TFT 502 of the pixel 501 can be held until the next writing is allowed.

Here, the display control part 404 controls a time in each frame period in which the opened state of the shutter part 104 included in each of the pixels 501 is maintained through the scanning line control part 403 and the data line control part 402 according to a gradation value. Accordingly, the respective pixels 501 are driven according to desired gradation values. At this time, the backlight control part 405 causes the respective pixels 501 to be sequentially irradiated with the lights having the respective colors of RGB, and controls the gradation values of the respective pixels 501 according to the irradiation of the lights having the respective colors. As a result, an image can be displayed. That is, the display device 100 displays the image by using a display system such as a so-called time division gray scale and a field sequential color method.

In addition, the structure and the operation of the respective pixels 501 are an example, and one or more embodiments of the present invention is not limited to the structure and the operation. The above structure may be replaced by a substantially same structure as the above structure, a structure having the same operation and effect, or a structure capable of achieving the same object. For example, in the above, although the description is made under the assumption that when the TFT 502 is turned on, the shutter part 104 is brought into the opened state. However, a structure may be such that when the TFT is turned off, the shutter part 104 is brought into the opened state, and the TFT is turned on in the other case. Alternatively, a structure may be such that two TFTs are provided, and when one of the TFTs is turned on, the shutter part 104 is brought into the opened state, and when the other TFT is turned on, the shutter part is brought into the closed state. That is, as long as the opened state or the closed state of the shutter part 104 can be controlled, any structure may be adopted.

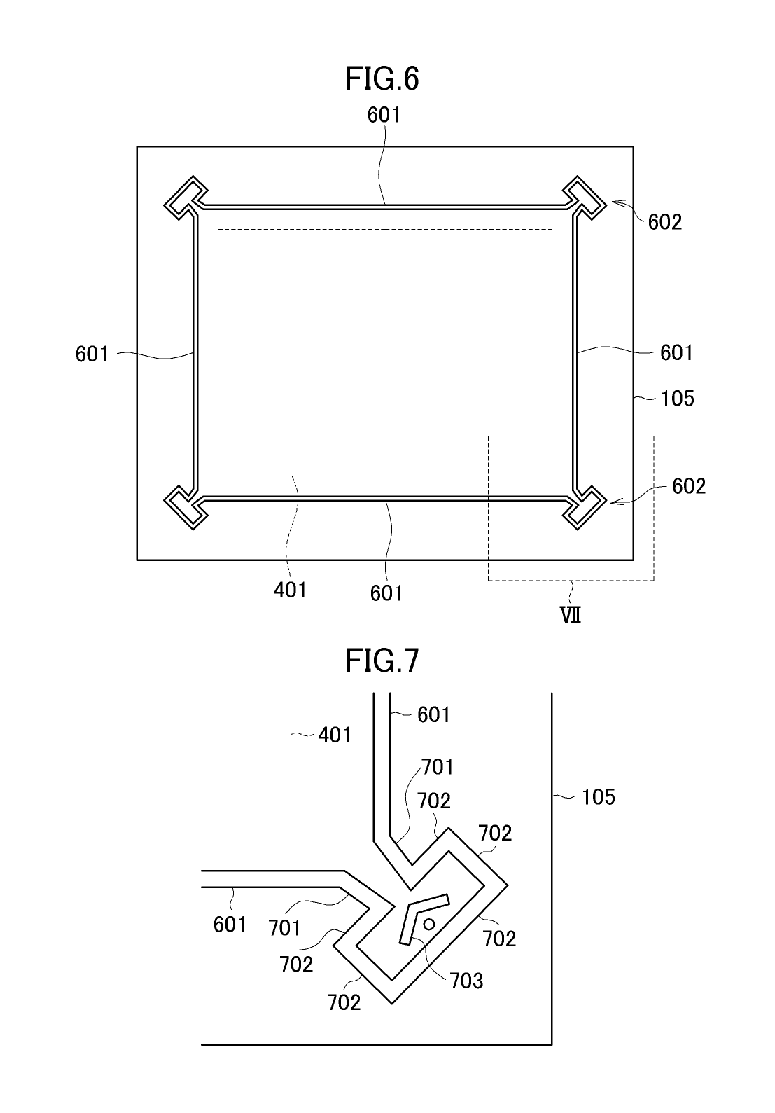

FIG. 6 is a view for explaining a seal member in the embodiment. As stated above, the area surrounded by the seal member 113 is provided between a pair of glass substrates (for example, the glass substrate 102 laminated with the aperture substrate 103 and the TFT substrate 105) in which the shutter parts 104 are provided, and the liquid to enhance the dielectric constant, such as, for example, silicone oil, is held in the area. In addition, the pair of glass substrates correspond to a first substrate and a second substrate recited in the claims.

As shown in FIG. 6, the seal member 113 includes, for example, liquid holding walls 601 and four bubble holding parts 602. The liquid holding walls 601 are arranged along respective sides of the pair of glass substrates and outside the display area 401 including the plural pixels 501. The bubble holding parts 602 are arranged at the ends of the liquid holding walls 601. In addition, the bubble holding parts 602 are also arranged outside the display area 401.

FIG. 7 is an enlarged view of the periphery of the bubble holding part shown in FIG. 6. Specifically, FIG. 7 is an enlarged view of an area indicated by VII in FIG. 6. As shown in FIG. 7, the bubble holding part 602 includes a guide wall 701 to guide a bubble generated in the liquid in the display area 401 and a holding wall 702 to hold the bubble guided by the guide wall 701.

The guide wall 701 is formed such that the width becomes narrow in the direction from the display area 401 to the holding wall 702. Thus, a bubble becomes apt to enter the guide wall 701 from the display area 401, and the bubble that is once entered in the area surrounded by the holding wall 702 becomes hard to pass the guide wall 701 and to again move to the display area 401. Besides, the width of the guide wall 701 is specifically, for example, about 0.1 mm to 0.5 mm.

For example, as shown in FIG. 7, the holding wall 702 forms an area having a substantially rectangular shape and surrounded by the holding wall 702 except for a portion where the guide wall 701 is connected to the holding wall 702. Specifically, the rectangular portion has a size of about 1 mm×1 mm. The guide wall 701 is formed to extend from the display area 401 side to the vicinity of the center of the holding wall 702. In addition, the shape of the area formed of the holding wall 702 is an example, and as long as a bubble can be held, another shape such as a substantially triangular shape or a substantially circular shape may be adopted.

Besides, the bubble holding part 602 may include a movement preventing wall 703, which prevents a bubble held in the area surrounded by the holding wall 702 from again moving to the display area 401, in the area surrounded by the holding wall 702. As shown in FIG. 7, the movement preventing wall 703 has an L shape, and has such a shape as to spread from an apex portion of the L shape toward the outside of the display area 401.

Accordingly, the bubble guided by the guide wall 701 moves from the center part of the area surrounded by the holding wall 702 toward the holding wall 702 by the movement preventing wall 703, and is guided to the back side of the movement preventing wall 703 (side opposite to the guide wall 701 with respect to the movement preventing wall 703). Accordingly, as compared with the case where the movement preventing wall 703 is not provided, the bubble holding part 602 can prevent the bubble that is held from moving to the display area 401 again more effectively.

Here, it is explained that an operation that the bubble holding part 602 holds a bubble generated in the liquid, such as silicone oil, sealed in the display area 401. When the display device 100 is used in, for example, a portable terminal or the like, the portable terminal is tilted at various angles at the operation or movement of a user.

Thus, a bubble generated in the display area 401 moves, for example, according to the movement of the display device 100 caused by the operation of the user, so that the bubble is guided from the display area 401 to the guide wall 701 of the bubble holding part 602, and is moved through the guide wall 701 into the area (inside of the bubble holding part 602) surrounded by the holding wall 702. Since there is a tendency that the bubble is generated mainly at an end of the display area 401, the bubble generated at the end of the display area 401 is easily guided to the bubble holding part 602 that is arranged outside the four corners of the display area 401.

According to this embodiment, for example, even when a bubble is generated in a liquid, such as silicone oil, which is sealed in the display area 401 at low temperature, the bubble is guided to the bubble holding part 602 and can be held in the bubble holding part 602 provided outside the display area 401. Accordingly, the influence of the bubble in the display area 401 is prevented, and consequently, the display device 100 having higher image quality can be provided.

The invention is not limited to the above embodiment, but may be replaced by a substantially same structure as the structure described in the above embodiment, a structure having the same operation and effect, or a structure capable of achieving the same object. For example, in the above embodiment, although the liquid holding walls 601, and the movement preventing wall 703, the guide wall 701 and the holding wall 702 in the bubble holding part 602 are formed of the same seal member 113, no limitation is made to this, and they may be formed of different materials.

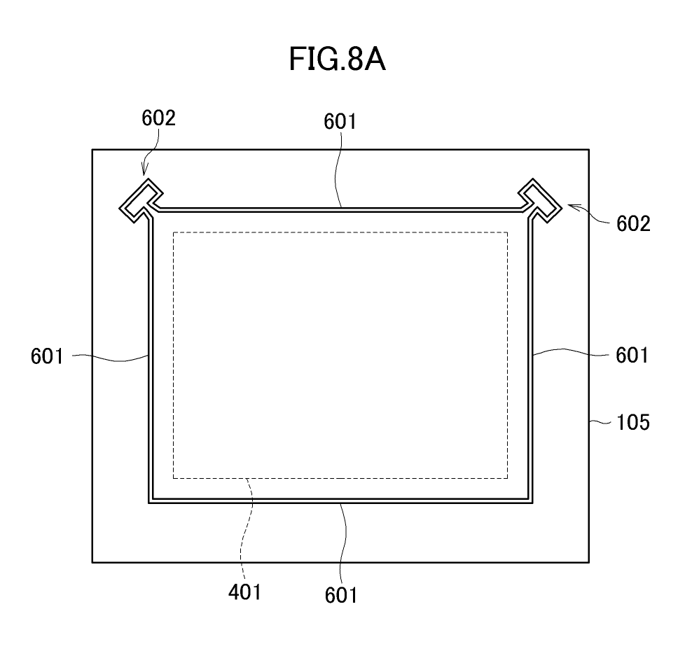

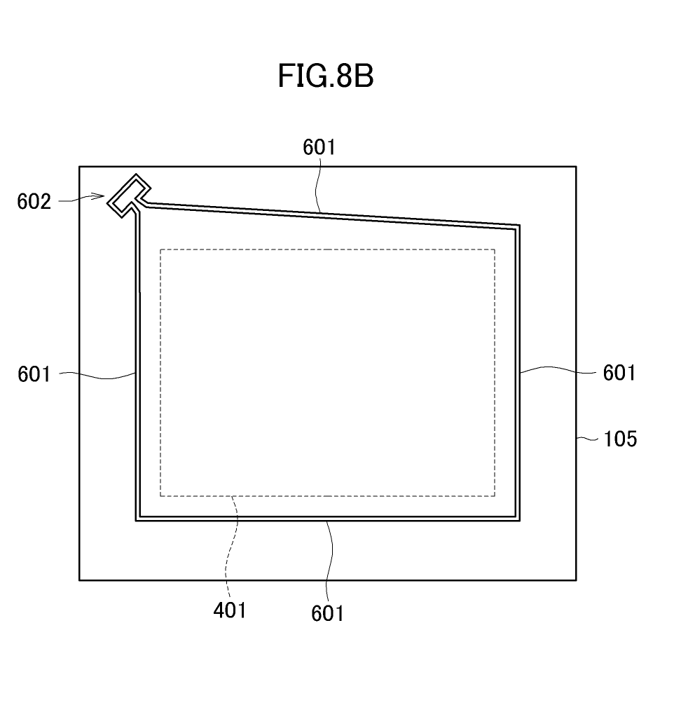

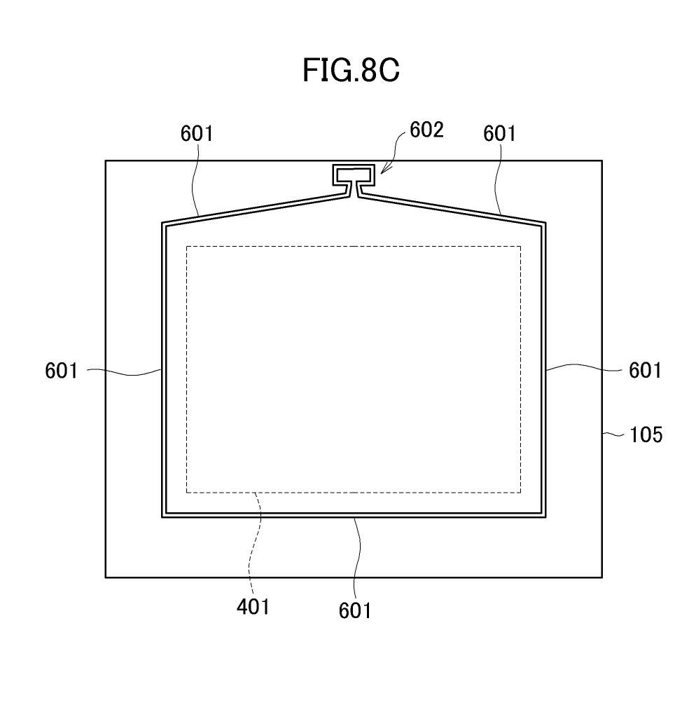

Besides, in the above embodiment, although the four bubble holding parts 602 are provided at the respective ends of the substrate on which the liquid is held, one or more embodiments of the present invention is not limited to the above, and a different number of bubble holding parts 602 may be provided or the bubble holding parts may be provided at different positions. Specifically, as shown in FIG. 8A, the bubble holding parts 602 may be provided at two ends of the four ends of the substrate at which the liquid is held.

In this case, for example, in the display device 100 (for example, a notebook computer) which is usually held such that a side on which the bubble holding parts 602 are provided is turned upward, since a generated bubble is directed upwardly, the bubble can be effectively held by the two bubble holding parts 602. Besides, in this case, the liquid holding wall 601 may be inclined to have an angle as set forth below, so that the generated bubble moves to the bubble holding parts 602 through the liquid holding wall 601.

Besides, in the embodiment, although it is explained that the liquid holding walls 601 are formed substantially in parallel to the respective sides of the glass substrate, one or more embodiments of the present invention is not limited to the above. For example, as shown in FIG. 8B or FIG. 8C, the liquid holding walls 601 may be formed to have an angle with respect to the side of the glass substrate toward the bubble holding part 602.

Specifically, for example, in FIG. 8B and FIG. 8C, it is assumed that the display device 100 is held in a state that an upper part in the drawing is turned upward. In this case, the display device may be formed so that the liquid holding walls 601 have an angle toward the bubble holding part 602, that is, the bubble is guided to the bubble holding part 602 by the liquid holding walls 601. In this case, the generated bubble moves to the bubble holding part 602 along the liquid holding walls 601 having the angle. Thus, the bubble holding part 602 can hold the bubble more effectively.

In addition, the display device 100 in the embodiment may be used as various display devices for information display, such as a display for personal computer, a display for receiving TV broadcasting, and a display for displaying announcement. Besides, the display device may be used as a display part of various electronic equipments such as a digital still camera, a video camera, a car navigation system, a car audio, a game equipment and a portable information terminal.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device comprising:
an aperture substrate including a plurality of openings arranged in a matrix form;
a plurality of shutter parts that are arranged between a first substrate and a second substrate correspondingly to the plurality of openings, wherein the plurality of shutter parts move in a horizontal direction relative to the aperture substrate so as to control an amount of light emitted from the plurality of openings;
a liquid holding wall configured to hold a liquid between the first substrate and the second substrate and is arranged to surround a display area including the plurality of shutter parts; and
at least one bubble holding part configured to hold a bubble that is generated in the liquid and is guided to the at least one bubble holding part, wherein the at least one bubble holding part is provided as a part of the liquid holding wall.

2. The display device according to claim 1, wherein the bubble holding part is arranged outside the display area.

3. The display device according to claim 1, wherein four bubble holding parts including the at least one bubble holding part are provided so as to be continuous with ends of the liquid holding wall.

4. The display device according to claim 1, wherein the at least one bubble holding part includes a guide wall to guide the bubble to an inside of the bubble holding part.

5. The display device according to claim 4, wherein the guide wall has a width which becomes narrow toward the outside of the display area.

6. The display device according to claim 1, wherein the at least one bubble holding part includes a movement preventing wall so as to prevent the bubble from moving to the display area from the bubble holding part.

7. The display device according to claim 6, wherein the movement preventing wall is formed in an L shape, and is arranged so as to cause the bubble guided from the guide wall to move toward an outside of the bubble holding part.

8. The display device according to claim 6, wherein the liquid holding wall, the bubble holding wall, the guide wall and the movement preventing wall are made of a same seal member.

9. The display device according to claim 1, wherein:
each of the shutter parts includes an electrode plate,
the display device further includes a power supply electrode plate arranged to face the electrode plate,
the shutter part is moved by applying a voltage between the electrode plate and the power supply electrode plate, and
the liquid enhances a dielectric constant between the electrode plate and the power supply electrode plate as compared with a case where the liquid is not sealed.

10. The display device according to claim 1, wherein the liquid is a silicone oil.

11. The display device according to claim 1, wherein the display area further includes a light source part, and the shutter parts control an amount of light emitted from the light source part through the plurality of openings of the aperture substrate.
